(19) United States
(12) Patent Application Publication
(10) Pub. No.: US 2014/0016315 A1
(43) Pub. Date: Jan. 16, 2014

(54) MICRO LOUVER

(71) Applicant: Scott S. YU, Tiburon, CA (US)

(72) Inventor: Scott S. YU, Tiburon, CA (US)

(21) Appl. No.: 13/940,225

(22) Filed: Jul. 11, 2013

Related U.S. Application Data
(60) Provisional application No. 61/671,018, filed on Jul. 12, 2012.

(51) Int. Cl. F21V 11/00; F21V 19/00

(52) U.S. Cl. CPC F21V 11/00; F21V 19/003
USPC 362/235; 29/831

(57) ABSTRACT

A device comprising a circuit board, said circuit board having a plurality of LEDs dispose on said circuit board, and a chassis, said chassis having a plurality of baffles, each baffle formed by bending a portion of the chassis substantially orthogonally to the surface of the chassis leaving a plurality of holes in said chassis, said holes spaced substantially the same spacing as the plurality of LEDs. The baffles may operate to shield light emitted from the LEDs to either 30 degrees, 45 degrees or 60 degrees. Also included is a housing operable to secure the circuit board and chassis into a fixed position.

### PRIORITY

This application claims the benefit of co-pending provisional patent application 61/671,018 entitled “Micro Louver,” filed on Jul. 12, 2012 by the same inventor which is incorporated into this document by reference as if fully set forth herein.

### BACKGROUND

The present invention relates generally to lighting systems, and more particularly to a modularized luminaire providing for a high degree of precise lighting in a limited space.

In lighting glare may be caused by the contrast between bright and dark lighting. For example, if only 1 luminaire is installed in a room, the occupants may sense significant glare, whereas if multiple luminaires are installed the glare will be reduced. Glare can be reduced or eliminated by adding shields (or baffles) to the luminaires to direct the light to reach a desired affect.

### SUMMARY

Disclosed herein is a device comprising a circuit board, said circuit board having a plurality of LEDs dispose on said circuit board, and a chassis, said chassis having a plurality of baffles, each baffle formed by bending a portion of the chassis substantially orthogonally to the surface of the chassis leaving a plurality of holes in said chassis, said holes spaced substantially the same spacing as the plurality of LEDs. The baffles may operate to shield light emitted from the LEDs to either 30 degrees, 45 degrees or 60 degrees. Also included is a housing operable to secure the circuit board and chassis into a fixed position.

The construction and method of operation of the invention, however, together with additional objectives and advantages thereof will be best understood from the following description of specific embodiments when read in connection with the accompanying drawings

### BRIEF DESCRIPTION OF THE DRAWINGS

FIG. 1 illustrates an exploded view of an embodiment of a luminaire.

FIG. 2 shows a range of light radiation patterns for different length circuit boards having different light densities and different height microlouvers.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### Detail Description

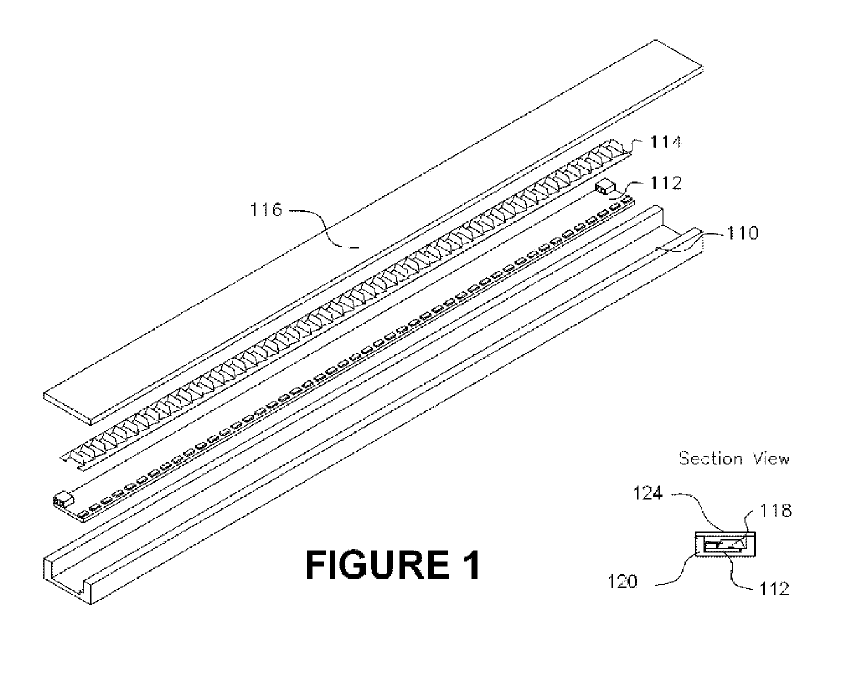

FIG. 1 illustrates an exploded view of an embodiment of a luminaire. In FIG. 1 a chassis 110 is formed for reception of certain parts of the luminaire. The chassis may be made from aluminum, plastic, or other suitable material. Disposed in the chassis 110 is an elongated substrate 112 which may be a conventional circuit board or other flexible material. The substrate 112 has one or more light sources, such as LEDs, aligned in an array. Disposed over the substrate 112 is a microlouver assembly 114. The microlouver 114 may be formed from plastic, stamped aluminum or some other suitable material. The microlouver assembly 114 is formed with multiple openings, each opening having at lest one tab (or baffle) 118 projecting orthogonally from the surface of the microlouver assembly 114. As shown, the microlouver assembly 114 is stamped from a single piece of aluminum such the microlouvers 118 are detents out of the microlouver assembly 118. When the microlouvers 118 are formed, the interstitial spaces are formed to match the spacing of the light sources on the circuit board 112. A lens (or dust cover) 116 is disposed over the microlouver assembly 114.

In some embodiments the baffles 118 may have different colored surfaces to modulate the reflection of light from the light sources out of the luminaire. Also a dust cover 124 may be employed to protect the light source or modulate the amount of light. An aluminum, or other suitable, housing 120 for supporting the LED board 112 and the dust cover 124 may be employed.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to affect such feature, structure or characteristic in connection with other embodiments whether or not explicitly described. Parts of the description are presented using terminology commonly employed by those of ordinary skill in the art to convey the substance of their work to others of ordinary skill in the art.

In operation, the spacing (or density) of the LEDs and the height of the microlouvers operate to effect certain light patterns. While FIG. 1 shows the microlouvers 118 as stamped from the same material as the microlouver assembly 114, there is no requirement that this limitation is used in every embodiment. For example and without limitation, different spacing of interstices and different heights of microlouvers may be formed the effect a desired lighting pattern.

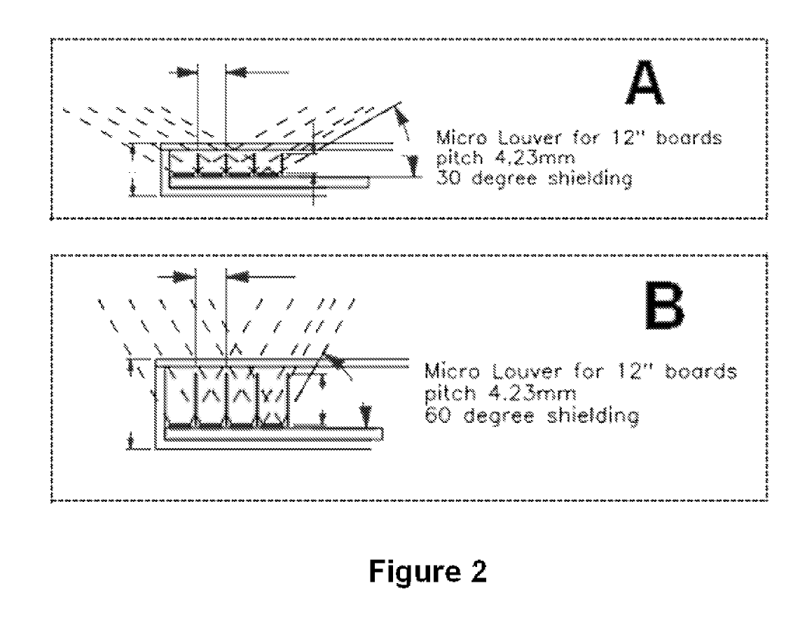

FIG. 2 shows a range of light radiation patterns for different length circuit boards having different light densities and different height microlouvers. For example the structure identified as “A” shows microlouvers for 12 inch circuit boards. The microlouver assembly provides for a pitch of 4.23 mm corresponding to the spacing of the light sources on the circuit board. With a louver height of 3 mm, the shielding for the light radiation is 30 degrees. In the structure identified as “B” the light sources have the same pitch of 4.23 mm, however the microlouvers are 7 mm high. This provides for a light radiation shielding of 60 degrees. Other alternatives are shown in Table 1.

TABLE 1

| | Board | | |
|---|---|---|---|
| Pitch | Length | Shielding | Height (H) |
| 4.7 mm | 10 inch | 30 Degrees | 3 mm |
| 6.47 mm | 12 inch | 60 Degrees | 15 mm |
| 9.41 mm | 10 inch | 60 Degrees | 15 mm |
| 9.41 mm | 10 inch | 30 Degrees | 6 mm |

One having skill in the art may effectuate many optical patterns by varying the height of the louvers in relation to the LED spacing. In certain embodiments different height louvers may be employed to allow for placement of luminaires in different environments. For example and without limitation, a luminaire may be created having a 30 degree light radiation pattern on one portion and a 60 degree light radiation pattern on another portion.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims.

What is claimed:

1. A device including:
a substrate, said substrate including a plurality of light sources disposed at a predetermined pitch;
a chassis, said chassis having a plurality of openings, said openings disposed at the predetermined pitch, and
one or more baffles disposed between said openings and aligned substantially orthogonally to said openings.

2. The device of claim 1 wherein the baffles are formed as detents out of the chassis.

3. The device of claim 1 wherein the light sources are LEDs.

4. The device of claim 1 wherein the chassis and baffles are stamped from a single piece of aluminum.

5. The device of claim 1 further including:
a mounting chassis operative to secure the substrate in position.

6. The device of claim 1 wherein the baffles extend substantially either 3 mm, 7 mm or 15 mm from the plane of the openings.

7. A method including:
disposing a plurality of light sources on a substrate;
selecting an desired angle of light radiation;
forming a microlouver assembly, said microlouver assembly containing holes at substantially the same spacing as the light sources, said microlouver assembly including baffles formed to provide the angle of radiation, and
disposing the microlouver assembly over the substrate.

7. The method of claim 7 wherein the baffles are formed as detents out of the chassis.

8. The method of claim 7 wherein the light sources are LEDs.

9. The method of claim 7 wherein the microlouver and baffles are stamped from a single piece of aluminum.

10. The method of claim 7 further including:
disposing the substrate on a chassis.

11. The method of claim 7 wherein the baffles extend substantially either 3 mm, 7 mm or 15 mm from the plane of the openings.

12. A device comprising:
a circuit board, said circuit board having a plurality of LEDs dispose on said circuit board, and
a chassis, said chassis having a plurality of baffles, each baffle formed by bending a portion of the chassis substantially orthogonally to the surface of the chassis leaving a plurality of holes in said chassis, said holes spaced substantially the same spacing as the plurality of LEDs.

13. The device of claim 12 wherein the baffles operate to shield light emitted from the LEDs to either 30 degrees, 45 degrees or 60 degrees.

14. The device of claim 12 further including a housing operable to secure the circuit board and chassis into a fixed position.
